(19) United States
(12) Patent Application Publication
(10) Pub. No.: US 2026/0066595 A1
(43) Pub. Date: Mar. 5, 2026

(54) MOUNTING PLATE, AND SET FORMED THEREFROM, AND DEVICE

(71) Applicant: WAGO Verwaltungsgesellschaft mit beschränkter Haftung, Minden (DE)

(72) Inventors: Philipp OBER-WOERDER, Kirchlengern (DE); Torben OBERHOMMERT, Minden (DE)

(73) Assignee: WAGO Verwaltungsgesellschaft mit beschränkter Haftung, Minden (DE)

(21) Appl. No.: 19/317,065

(22) Filed: Sep. 2, 2025

(30) Foreign Application Priority Data
Sep. 3, 2024 (DE) 20 2024 105 011.8

(51) Int. Cl. H01R 13/73; F16M 13/02; H01R 13/58

(52) U.S. Cl. CPC H01R 13/73; F16M 13/02; H01R 13/58

(57) ABSTRACT

A mounting plate, including a main body in the form of a flat plate, which has a first main surface and a second main surface facing away therefrom. The main surfaces being the surface sides of the main body having the largest surface unit. At least one first latching element is provided, to which an electrical plug connector having at least one second latching element may be fastened with the aid of its at least one second latching element by the form-fitting engagement of the first latching element with the second latching element. A set formed from a mounting plate and a plug connector as well as a device which includes a mounting plate, a plug connector, and a further object are also provided.

This nonprovisional application claims priority under 35 U.S.C. § 119(a) to German Patent Application No. 20 2024 105 011.8, which was filed in Germany on September 3, 2024, and which is herein incorporated by reference.

### BACKGROUND OF THE INVENTION

### Field of the invention

The invention relates to a mounting plate, including a main body in the form of a flat plate, which has a first main surface and a second main surface facing away therefrom, these main surfaces being the surface sides of the main body having the largest surface unit, and including at least one first latching element, to which an electrical plug connector having at least one second latching element may be fastened with the aid of its at least one second latching element by the form-fitting engagement of the first latching element with the second latching element. The invention also relates to a set formed from a mounting plate and a plug connector as well as a device which includes a mounting plate, a plug connector, and a further object.

### Description of the Background Art

A generic mounting plate is known from DE 20 2017 104 144 U1.

### SUMMARY OF THE INVENTION

An object of the invention is to provide a mounting plate which is improved over the prior art, and arrangements formed therefrom.

In an example, the mounting plate can have at least one first latching tab which protrudes from the main body and is elastically deflectable with respect to the main body, the at least one first latching element being arranged on the first latching tab, the latching between the first latching element and the second latching element of the plug connector being able to be released by elastically deflecting the first latching tab. A construction of this type permits an easy latching of the mounting plate to the plug connector and likewise an easy release of the mounting plate, in that the first latching tab is elastically deflected. In particular, the latching may be released without a tool and in a nondestructive manner. In one advantageous embodiment, the first latching tab may be spring-elastically deflectable, so that, in the deflected state, it has the attribute of springing back into the initial position. Due to the first latching element, the plug connector may be latched to the mounting plate in an end position of the assembly.

The mounting plate may be particularly efficiently and cost-effectively provided in that it is manufactured as a plastic component, for example in an injection molding process. The first and second main surfaces are, as mentioned, the surface sides of the plate having the largest surface unit and are therefore not the narrow sides of the plate. The flat plate may be designed as a level plate or as an at least partially domed plate.

The first latching tab can have a manual release section, on which an actuating force can be applied to the first latching tab for the purpose of elastically deflecting the first latching tab, the manual release section being situated at a farther distance from the main body than the first latching element arranged on the first latching tab. In this way, a defined manual actuating element is provided for the manual actuation of the first latching tab. The manual release section may be advantageously placed so favorably that it may be easily gripped by the user even in the state of the mounting plate mounted on the plug connector. In this state, for example, the manual release section may protrude slightly over the edge of the housing of the plug connector.

The mounting plate may be designed to have an essentially uniform material thickness in the region of the main body, the first latching tab, and/or the manual release section. It is also possible that the first latching tab has a molded-on joint, with the aid of which the first latching tab is connected to the main body for the purpose of further improving the deflectability of the first latching tab. The joint may be formed, for example, by a materially bonded connection of the first latching tab to the main body, the material thickness and/or the width of the first latching table being able to be reduced in the region of the joint.

The mounting plate can be used, in particular, to fasten the plug connector to a further object, for example a mounting adapter, a housing part of an electrical apparatus, a connecting cable connected to the plug connector, or another object. The mounting plate may be set up on the side facing away from the main surface for support on this further object. For example, the second main surface may be used as a support surface for the further object. In addition, portions of the surfaces of the first latching tab arranged on the side of the second support surface may also be used, at least in part, as a support surface.

The manual release section can be arranged in a region of the mounting plate on which the mounting plate is arranged on the side facing away from the first main surface for support on a further object, on which the plug connector is to be fixed with the aid of the mounting plate. Due to the fact that the manual release section is arranged in this support region, the deflection of the first latching tab is prevented or at least made difficult in the state of the mounting plate mounted on the further object, because the deflectability is then blocked due to the support on the further object. This easily permits an additional securing of the latching of the plug connector on the mounting plate.

The mounting plate can have a second latching tab, which protrudes from the main body at a distance from the first latching tab and is elastically deflectable with respect to the main body, a further first latching element being arranged on the second latching tab, the latching between the further first latching element and a further second latching element of the plug connector being able to be released by elastically deflecting the second latching tab. The security of the latching of the plug connector on the mounting plate may be further improved by a second latching tab of this type. In particular, the firm seating on the plug connector may be ensured. The second latching tab may be provided with the same design as the first latching tab with respect to one or multiple of the aforementioned features of the first latching tab. The second latching tab may protrude from the main body, for example in parallel to the first latching tab, an intermediate space being able to be formed between the first and second latching tabs.

The second latching tab may have a manual release section, on which an actuating force is to be applied to the second latching tab for the purpose of elastically deflecting the second latching tab, the manual release section being situated at a farther distance from the main body than the further first latching element arranged on the second latching tab.

The first latching tab can be connected to the second latching tab via at least one connecting web, the connecting web being situated at a distance from the main body. The mounting plate is made even more robust and user-friendly hereby. In addition, the connecting web may be used as a pivot point and, together with portions of the plug connector, provide a counter-torque to lever forces occurring on the plug connector. This is advantageous, in particular, when using plug connectors which are to be actuated via an actuating lever for the purpose of actuating a spring-force clamping connection arranged therein. Due to the connecting web, an improved absorption of the lever force on the plug connector by an additional support surface formed by the connecting web on the further object is possible.

For example, the manual release sections of the first and second latching tabs may be connected to each other via the connecting web. This has the advantage that, to release the latching of the two latching tabs from the plug connector, only one actuation is needed, which may be applied to the connecting web.

The mounting plate can have at least one elongated, rail-like first fixing element on the first main surface, to which the plug connector may be fastened in a form-fitting manner with the aid of a second fixing element designed as a mating piece on the plug connector, in that the first and second fixing elements are pushed into each other in an insertion direction in parallel to the main surface. A type of prefixing of the plug connector on the mounting plate may take place with the aid of the rail-like first fixing element, for example in such a way that the plug connector is fastened to the mounting plate in two spatial directions by the connection between the first fixing element and the second fixing element. The final fixing in the third spatial direction then takes place by the latching of the plug connector to the first and/or second latching tab.

The at least one first latching element can be arranged behind the first fixing element in the insertion direction. This is necessary for an easy handling of the mounting plate or an easy assembly of the plug connector with the mounting plate.

In an example, one, multiple or all first latching element(s) can be designed as a latching element protruding with respect to the main surface. The second latching element on the plug connector may then be designed, for example, as a latching indentation. This permits an easy, ergonomic, and reliable latching of the plug connector to the first main surface. The protruding latching element(s) may be designed, for example, as latching hooks and/or latching elements of a tongue-and-groove connection having, for example, a dovetail profile. Alternatively, one, multiple, or all first latching elements may be designed as a latching element which does not protrude with respect to the first main surface, for example as a latching indentation.

The mounting plate can have a retaining element on the second main surface, with the aid of which the mounting plate may be fastened in a form-fitting manner to a further object. This permits an easy and fast fastening of the mounting plate to the further object. For example, the mounting plate may be latched or clipped to the further object via the retaining element.

The mounting plate can have at least one cable fixing region, in which the electrical cables connected to electrical plug connectors attached to the mounting plate may be fixed. This has the advantage that the cables connected to the plug connector, which is latched to the mounting plate, may be easily fixed to the mounting plate in the direct vicinity of the plug connector. In this way, the mounting plate provides an integrated strain relief device for the electrical cables. The mounting plate may have, for example, multiple through-openings in the cable fixing region, through which cable fixers, such as cable ties, may be guided. The cable fixing region may be designed to form a single piece with the flat plate on which the first latching elements are arranged.

The first latching element may be matched to the second latching element of the plug connector, for example, in such a way that the plug connector may be fastened to the mounting plate only in an alignment with its plug face, i.e., in a direction with the plug face facing a plug face side of the mounting plate. The plug connector fastened to the mounting plate is therefore automatically oriented with its cable output side in the direction of the manual release section and/or the first latching element of the mounting plate.

The object mentioned at the outset is also achieved by a set formed from a mounting plate of the type explained above and a plug connector, which has at least one second latching element. The second latching element of the plug connector is matched to the first latching element of the mounting plate, so that an easy latching of the plug connector to the mounting plate is made possible.

The object mentioned at the outset is furthermore achieved by a device including a mounting plate of the type explained above, a plug connector, which has at least one second latching element and is latched to the at least one first latching element of the mounting plate with the aid of the second latching element, and a further object, to which the mounting plate is attached via its retaining element. The advantages explained above may also be implemented hereby.

The at least one manual release section can be blocked against a deflection of the first latching tab by the further object. An additional securing of the latching of the plug connector to the mounting plate is easily implemented hereby.

A plug connector may be, for example, a plug part or a socket part for establishing an electrical connection. The plug connector may be configured for connection to a mating plug connector. The plug connector or the mating plug connector may be, for example, a male connector or a female connector. The plug connector or the mating plug connector may have, for example, male plug contacts or female plug contacts.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a mounting plate in a perspective view;

FIG. 2 shows the mounting plate according to FIG. 1 in a side view;

FIG. 3 shows the mounting plate according to FIG. 1 in a top view;

FIG. 4 shows a plug connector with two mounting plates fastened thereto in a perspective view;

FIG. 5 shows the arrangement according to FIG. 4 in a side view; and

FIG. 6 shows the arrangement according to FIG. 5 when fastened to a further object.

### DETAILED DESCRIPTION

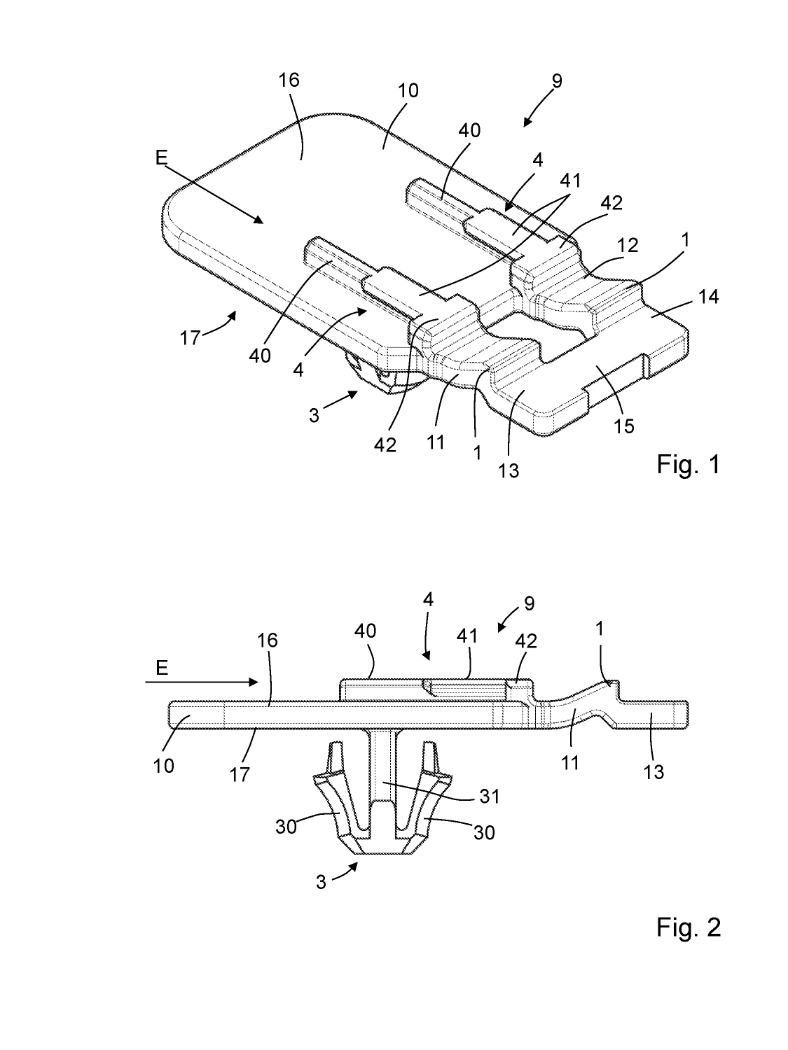

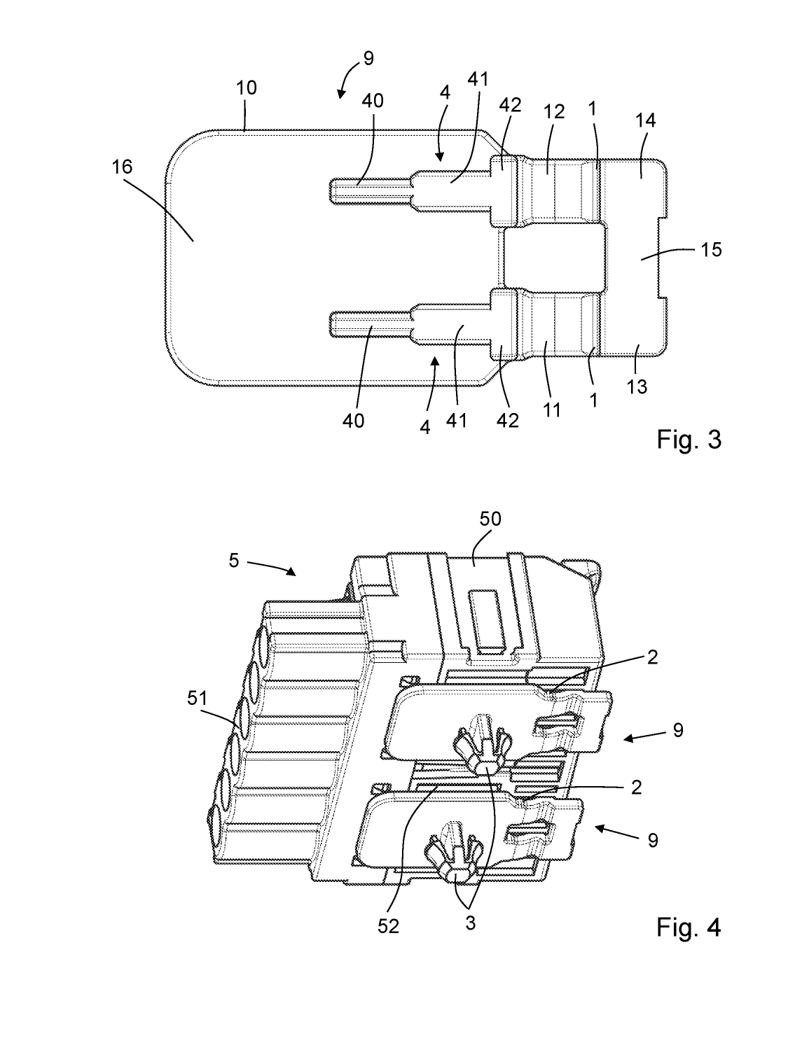

A mounting plate 9, which has a main body 10 in the form of a flat plate, is apparent in FIGS. 1 through 3. It is apparent that main body 10 is designed as a relatively flat, level plate, whose thickness is significantly smaller than its length and width. The thickness of main body 10 may be, for example, less than 1/10 of the largest dimension of length and width.

This plate-shaped main body 10 has a first main surface 16 on one side and a second main surface 17 on the side facing away therefrom, which are the surface sides of main body 10 having the largest surface unit. On a narrow side, a first latching tab 11 and a second latching tab 12, which is situated essentially in parallel to first latching tab 11 at a certain distance therefrom, protrude from main body 10. A first latching element 1 is formed in each case on first latching tab 11 and second latching tab 12, for example in the form of a projection protruding with respect to first main surface 16. First latching tab 11 has a manual release section 13 behind first latching element 1, viewed from main body 10. Similarly, second latching tab 12 has a manual release section 14 behind first latching element 1. Manual release sections 13, 14 are connected to each other in the transverse direction by a connecting web 15. Connecting web 15 is situated at a distance from main body 10, i.e., an intermediate space is present between connecting web 15 and main body 10.

As is apparent, mounting plate 9 may additionally have at least one or, as illustrated, two elongated, rail-like first fixing elements 4 arranged in parallel to each other on first main surface 16. A plug connector may be pushed onto this rail-like first fixing element 4 in a form-fitting manner in an insertion direction E with the aid of a second fixing element designed as a mating piece. First fixing elements 4 initially have a guide section 40 in insertion direction E, which is used for the defined guidance of the plug connector during the insertion movement. A fixing section 41 adjoins guide section 40 in insertion direction E, which may have, for example, a contour with an undercut, for example a T-shaped contour in cross-section. An end stop 42 adjoins fixing section 41, by means of which the insertion movement of the plug connector is limited to an end value. Upon reaching particular end stop 42 or shortly before reaching it, a second latching element on the plug connector then engages with particular first latching element 1 on mounting plate 9.

It is also apparent that mounting plate 9 has a retaining element 3 on second main surface 17, which protrudes from second main surface 17. Retaining element 3 is formed by a support arm 31 extending from second main surface 17 and two spring-elastic latching legs 30. Spring-elastic latching legs 30 extend from the end of support arm 31 facing away from second main surface 17 back in the direction of second main surface 17.

FIG. 4 shows a plug connector 5, which includes a housing 50. Housing 50 has a plug face 51 on one side. On the side of plug face 51, a mating plug connector designed as a mating piece may be connected to plug connector 5 for the purpose of forming an electrical plug connection.

Multiple second latching elements 2, are formed on one side of housing 50, for example in the form of indentations, into which a particular first latching element 1 may be snapped and latched thereto. Elongated second fixing elements 52 are additionally present, which are designed as receptacles for first fixing elements 4 of mounting plate 9 in terms of their shape.

As is apparent, one or multiple mounting plates 9 may be fastened and latched to plug connector 5 with the aid of first fixing elements 4 and first latching elements 1. This unit formed from plug connector 5 and mounting plates 9 may then be fastened to a further object via retaining elements 3. It is also conceivable that the multiple mounting plates 9 illustrated are combined into one mounting plate having multiple retaining elements 3 as well as multiple first and second latching tabs 11, 12. Only one connecting web 15 may therefore be present.

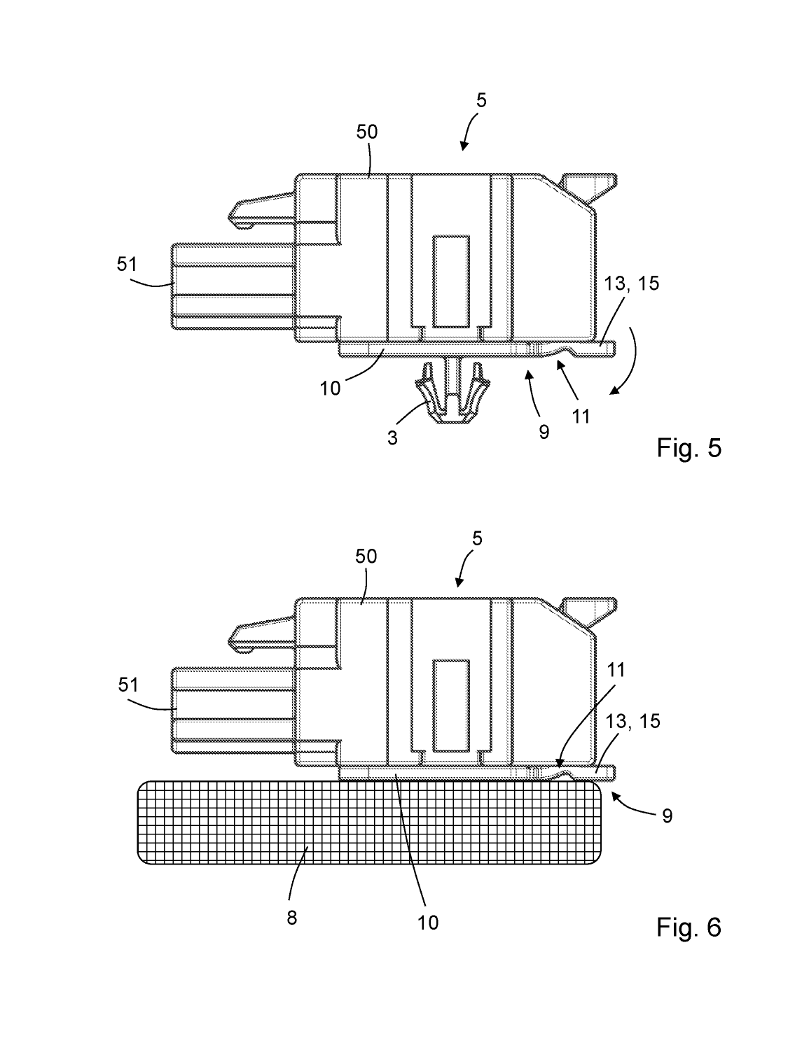

FIG. 5 shows the arrangement according to FIG. 4 in a side view. It is apparent that mounting plate 9 protrudes slightly with respect to housing 50 of plug connector 5 in the region of connecting web 15 or manual release sections 13, 14, so that, in this state, the latching of mounting plate 9 to plug connector 5 may easily take place by deflecting first and second latching tabs 11, 12.

If the arrangement according to FIG. 5 is then fastened to a further object 8, as illustrated in FIG. 6, mounting plate 9 adjoins this further object 8 with its second main surface 17. The deflection of first and second latching tabs 11, 12 may then be blocked by further object 8.

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. A mounting plate comprising:
a main body in the form of a flat plate, which has a first main surface and a second main surface facing away therefrom, the first main and second main surfaces being the surface sides of the main body having a largest surface unit;
at least one first latching element to which an electrical plug connector, which has at least one second latching element, is adapted to be fastened via the at least one second latching element by a form-fitting engagement of the first latching element with the second latching element; and
at least one first latching tab, which protrudes from the main body and is elastically deflectable with respect to the main body, the at least one first latching element being arranged on the first latching tab, a latching between the first latching element and the second latching element of the plug connector being able to be released by elastically deflecting the first latching tab.

2. The mounting plate according to claim 1, wherein the first latching tab has a manual release section, on which an actuating force is to be applied to the first latching tab for elastically deflecting the first latching tab, the manual release section being situated at a farther distance from the main body than the first latching element arranged on the first latching tab.

3. The mounting plate according to claim 2, wherein the manual release section is arranged in a region of the mounting plate on which the mounting plate is arranged on the side facing away from the first main surface for support on a further object, to which the plug connector is to be fixed via the mounting plate.

4. The mounting plate according to claim 1, wherein the mounting plate has a second latching tab, which protrudes from the main body at a distance from the first latching tab and is elastically deflectable with respect to the main body, a further first latching element being arranged on the second latching tab, the latching between the further first latching element and a further second latching element of the plug connector being able to be released by elastically deflecting the second latching tab.

5. The mounting plate according to claim 4, wherein the first latching tab is connected to the second latching tab via at least one connecting web, the connecting web being situated at a distance from the main body.

6. The mounting plate according to claim 1, wherein the mounting plate has at least one elongated, rail-like first fixing element on the first main surface, to which the plug connector is adapted to be fastened in a form-fitting manner with the aid of a second fixing element designed as a mating piece on the plug connector, and wherein the first and second fixing elements are pushed into each other in an insertion direction parallel to the first main surface.

7. The mounting plate according to claim 6, wherein the at least one first latching element is arranged behind the first fixing element in the insertion direction.

8. The mounting plate according to claim 1, wherein, multiple, or all first latching element(s) is/are designed as a latching element protruding with respect to the first main surface.

9. The mounting plate according to claim 1, wherein the mounting plate has a retaining element on the second main surface, with the aid of which the mounting plate is adapted to be fastened in a form-fitting manner to a further object.

10. A set comprising the mounting plate according to claim 1, and a plug connector that has at least one second latching element.

11. A device comprising:
the mounting plate according to claim 9;
a plug connector that has at least one second latching element and is latched to the at least one first latching element of the mounting plate via the second latching element; and
a further object, to which the mounting plate is adapted to be fastened via its retaining element.

12. The device according to claim 11, wherein the at least one manual release section is blocked against a deflection of the first latching tab by the further object.
